(19) United States
(12) Patent Application Publication
(10) Pub. No.: US 2025/0238828 A1
(43) Pub. Date: Jul. 24, 2025

(54) INFORMATION PROCESSING APPARATUS, INFORMATION PROCESSING METHOD, AND NON-TRANSITORY COMPUTER READABLE STORAGE MEDIUM

(71) Applicant: LY Corporation, Tokyo (JP)

(72) Inventor: Takuro MORI, Tokyo (JP)

(21) Appl. No.: 19/017,022

(22) Filed: Jan. 10, 2025

(30) Foreign Application Priority Data
Jan. 19, 2024 (JP) 2024-006795

(51) Int. Cl. G06Q 30/0204; G06Q 30/0601; G09B 29/10

(52) U.S. Cl. CPC G06Q 30/0205; G06Q 30/0639; G09B 29/106

(57) ABSTRACT

An information processing apparatus according to the present application includes a reception unit, an analysis unit, and a provision unit. The reception unit receives designation of a store. The analysis unit performs, based on information concerning a user of the store, first estimation processing of estimating a trading area of the store, the designation of which has been received by the reception unit, and second estimation processing of estimating characteristics of the trading area estimated in the first estimation processing. The provision unit provides map information including information indicating the trading area estimated by the analysis unit and information indicating the characteristics of the trading area.

### CROSS-REFERENCE TO RELATED APPLICATIONS

The present application claims priority to and incorporates by reference the entire contents of Japanese Patent Application No. 2024-006795 filed in Japan on Jan. 19, 2024.

### BACKGROUND OF THE INVENTION

### 1. Field of the Invention

The present invention relates to an information processing apparatus, an information processing method, and a non-transitory computer-readable storage medium.

### 2. Description of the Related Art

A trading area analysis for planning a management strategy in a store has been performed. For example, Japanese Patent Application Laid-open No. 2016-170778 proposes a technique for analyzing a trading area designated by a client device.

However, in the related art explained above, since the trading area to be analyzed is a trading area designated by the client device, in some cases, a trading area of a store is not appropriately set and the accuracy of the analysis of the trading area is inappropriate and there is room for improvement.

### SUMMARY OF THE INVENTION

An information processing apparatus according to the present application includes a reception unit, an analysis unit, and a provision unit. The reception unit receives designation of a store. The analysis unit performs, based on information concerning a user of the store, first estimation processing of estimating a trading area of the store, the designation of which has been received by the reception unit, and second estimation processing of estimating characteristics of the trading area estimated in the first estimation processing. The provision unit provides map information including information indicating the trading area estimated by the analysis unit and information indicating the characteristics of the trading area.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram for explaining information processing according to an embodiment;

FIG. 2 is a diagram illustrating an example of a configuration of an information processing system according to the embodiment;

FIG. 3 is a diagram illustrating an example of a configuration of an information processing apparatus according to the embodiment;

FIG. 4 is a diagram illustrating an example of a user information table stored in a user information storage unit of the information processing apparatus according to the embodiment;

FIG. 5 is a diagram illustrating an example of a store information table stored in a store information storage unit of the information processing apparatus according to the embodiment;

FIG. 6 is a diagram illustrating an example of a prompt used by an analysis unit of a processing unit in the information processing apparatus according to the embodiment;

FIG. 7 is a diagram illustrating an example of map information provided by a provision unit of the processing unit in the information processing apparatus according to the embodiment and displayed on the terminal device;

FIG. 8 is a flowchart illustrating an example of information processing by the processing unit of the information processing apparatus according to the embodiment; and

FIG. 9 is a hardware configuration diagram illustrating an example of a computer that implements the functions of the information processing apparatus according to the embodiment.

### DETAILED DESCRIPTION OF THE PREFERRED EMBODIMENTS

A mode (hereinafter referred to as “embodiment”) for implementing an information processing apparatus, an information processing method, and a non-transitory computer-readable storage medium according to the present application are explained in detail below with reference to the drawings. Note that the information processing apparatus, the information processing method, and the non-transitory computer-readable storage medium according to the present application are not limited by the embodiment. In addition, embodiments can be combined as appropriate within a range in which processing contents do not contradict one another. In the following embodiments, the same parts are denoted by the same reference numerals and signs, and redundant explanation is omitted.

### 1. Example of Information Processing

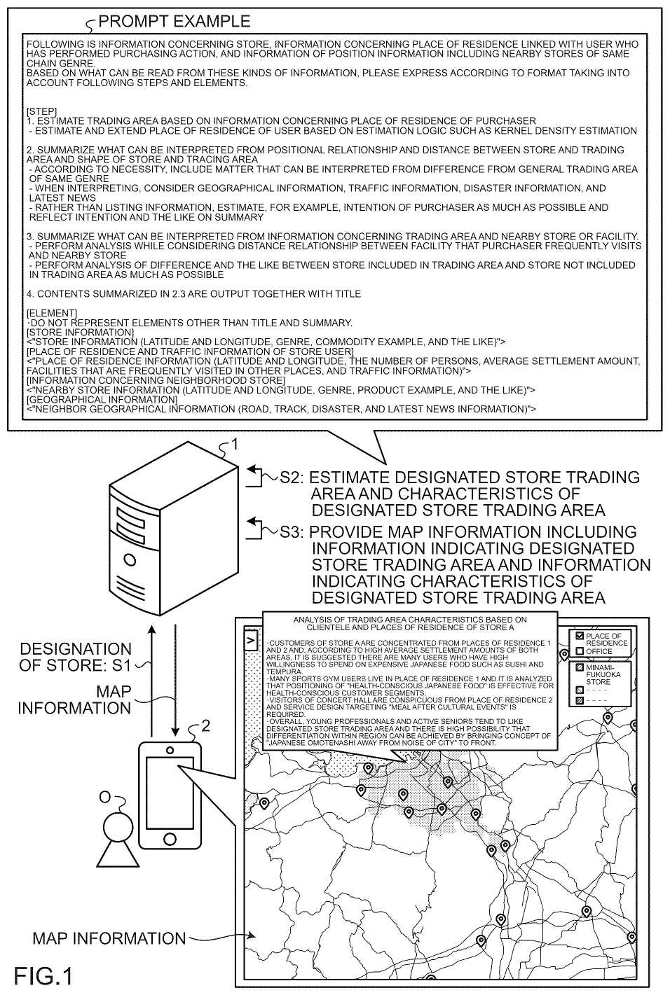

First, an example of information processing according to the embodiment is explained with reference to FIG. 1. FIG. 1 is a diagram for explaining information processing according to an embodiment;

An information processing apparatus 1 illustrated in FIG. 1 is an information processing apparatus that cooperates with a terminal device 2 of a service user O and provides various services to the service user O online and is implemented by, for example, one or more servers or a cloud system. The terminal device 2 is, for example, a smartphone, a tablet terminal, or a personal computer.

A service provided to the service user O by the information processing apparatus 1 is, for example, a store trading area related analysis service. For example, map information in which information concerning a trading area of a store designated by the service user O is arranged is transmitted to the terminal device 2 of the service user O.

As illustrated in FIG. 1, the information processing apparatus 1 receives designation of a store by the service user O (step S1). For example, when receiving a trading area information request including store information indicating the store designated by the service user O and transmitted from the terminal device 2, the information processing apparatus 1 receives the designation of the store by the service user O based on the store information included in the trading area information request. In the following explanation, the store designated in step S1 is sometimes described as designated store.

For example, the service user O operates the terminal device 2 to transmit a use request from the terminal device 2 to the information processing apparatus 1. The use request includes, for example, information indicating a position designated by the service user O or information indicating a region designated by the service user O. In the following explanation, a region including the position designated by the service user O or the region designated by the service user O is sometimes described as designated region.

When receiving the use request transmitted from the terminal device 2, the information processing apparatus 1 transmits store designation information including list information indicating a list of stores present in the designated region and map information of the designated region to the terminal device 2.

When receiving the store designation information transmitted from the information processing apparatus 1, the terminal device 2 displays list information indicating a list of stores present in the designated region and map information of the designated region based on the received store designation information. In the list information, stores present in the designated region are arranged to be individually designable. In the map information of the designated region, store figures indicating the positions of the stores present in the designated region are arranged to be individually designable on the map.

The service user O can designate a store set as an analysis target among a plurality of stores included in the list information displayed on the terminal device 2 and can designate a store figure corresponding to the store set as the analysis target among a plurality of store figures included in the map information displayed on the terminal device 2.

When the service user O designates a store or a store figure, the terminal device 2 transmits, to the information processing apparatus 1, a trading area information request in which information indicating the store designated by the service user O or information indicating a store corresponding to the store figure designated by the service user O is included as store information.

Subsequently, the information processing apparatus 1 performs, based on the information concerning the user of the designated store, first estimation processing of estimating a trading area of the designated store that is the store, the designation of which has been received in step S1, and second estimation processing of estimating characteristics of the trading area of the designated store estimated in the first estimation processing (step S2).

For example, in the first estimation processing, the information processing apparatus 1 estimates a trading area of the designated store based on the information of the user of the designated store. The user of the designated store is a user having a history of one or more of a visit to the designated store, a purchase of a commodity at the designated store, and a use of a service at the designated store but is not limited to such an example and may be, for example, a user whose average stay time at the designated store is equal to or longer than a predetermined period. In the following explanation, the user of the designated store is sometimes described as store user.

Information concerning the store user includes, for example, information indicating a place of sojourn of the store user or information indicating a position history of the store user. The information indicating the place of sojourn of the store user is, for example, information indicating the latitude and the longitude of the place of sojourn of the store user but may be information indicating an address.

The place of sojourn of the store user is, for example, a location where the store user habitually stays and is, for example, a place of residence of the store user or a place of work of the store user. Note that the place of sojourn of the store user may be a place where the store user temporarily stays and may be, for example, an accommodation facility of the store user or an amusement facility visited by the store user.

Furthermore, the information concerning the store user may further include, for example, one or more pieces of information among information indicating an attribute of the store user, information indicating a use history of the designated store by the store user, information indicating a facility used by the store user, information indicating means of transportation used by the store user, and information indicating a position history of the store user.

The information indicating the attribute of the store user is a demographic attribute, a psychographic attribute, or the like of the store user. The demographic attribute is, for example, sex, age, a place of residence, a place of work, and an occupation. The psychographic attribute is an object of interest such as travel, clothes, cars, and religion, a lifestyle, an idea, a tendency of an idea, and the like.

The use history of the designated store by the store user includes, for example, payment amounts and an average payment amount of the store user, contents and genres of purchased commodities or purchased services of the store user, and stay times and an average stay time of the store user but is not limited to such an example.

For example, in the first estimation processing, the information processing apparatus 1 estimates a trading area of the designated store based on information indicating place of sojourns of store users. For example, the information processing apparatus 1 estimates a trading area of the designated store using an estimation method such as kernel density estimation based on the place of sojourns of the store users. For example, the information processing apparatus 1 estimates one or more regions, the density of which is equal to or larger than a predetermined value, as a trading area of the designated store.

In the first estimation processing, for example, the information processing apparatus 1 can determine whether the number of store users is equal to or larger than a predetermined number for each predetermined unit region. The information processing apparatus 1 can estimate, as a trading area of the designated store, a set of unit regions where the number of store users is equal to or larger than the predetermined number.

The information indicating the place of sojourn of the store user is information indicating a place of residence set by the store user, information indicating a place of work set by the store user, or the like. However, the information processing apparatus 1 can estimate information indicating various places of sojourns of the store user based on the information indicating the position history of the store user.

For example, the information processing apparatus 1 can estimate a place of residence of the store user, a place of work of the store user, a place where the store user has temporarily stayed, and the like from stay patterns at positions of the store user based on the information indicating the position history of the store user. In the following explanation, the trading area of the designated store estimated in the first estimation processing is sometimes referred to as designated store trading area.

The information processing apparatus 1 can also estimate the designated store trading area based on a store user satisfying a specific condition. For example, when information indicating a specific condition is included in the trading area information request received in step S1, the information processing apparatus 1 estimates the designated store trading area from the place of sojourn of the store user satisfying the specific condition indicated by the trading area information request.

The specific condition is, for example, an attribute of the store user, a type of a place of sojourn of the store user, a facility used by the store user, means of transportation used by the store user, purchase of a specific commodity or use of a specific service of the store user in the designated store, and an average stay time of the store user in the designated store but is not limited to such an example.

In the second estimation processing, the information processing apparatus 1 estimates characteristics of the designated store trading area based on, for example, information concerning the user of the designated store, information indicating a geographical relationship between the designated store and the designated store trading area, geographical information around the designated store, traffic information around the designated store or around the designated store trading area, information concerning a related location that is another store having a predetermined relationship with the designated store, and information concerning a related location that is another store or facility present around the designated store or around the designated store trading area.

The geographical information is, for example, information indicating topography, information indicating a passage, information indicating a public institution route, information indicating traffic regulations or signs, information of news articles, information concerning disasters, and information of facilities or stores but is not limited to such an example.

The geographical relationship between the designated store and the designated store trading area is a positional relationship between the designated store and the designated store trading area, a distance and topography between the designated store and positions of the designated store trading area, and the like but is not limited to such an example. The distances between the designated store and the positions of the designated store trading area are, for example, moving distances between the designated store and the positions of the designated store trading area but may be linear distances between the designated store and the positions of the designated store trading area. The topography between the designated store and the positions of the designated store trading area is, for example, the magnitude and the number of gradients of a moving path to the designated store, the length and the number of curves, and the like, but is not limited to such an example.

The traffic information of the designated store trading area also includes, for example, information such as information concerning a road network of the designated store trading area, information such as a state of the road network of the designated store trading area (for example, under construction or closed to traffic), and operation information of means of transportation of the designated store trading area. Other stores (examples of the associated locations) having a predetermined relationship with the designated store are, for example, the same chain stores as the designated store or the same genre as the designated store but are not limited to such an example.

The use history of the user at the related location is, for example, payment amounts and an average payment amount of the user, contents and genres of purchased commodities or purchased services of the user, and stay times and an average stay time of the store user but is not limited to such an example.

The related location information is, for example, information indicating a position (for example, the latitude and the longitude or an address) of the related location, information indicating a genre of the related location, information concerning a user who uses the related location, information indicating a use history of the user in the related location, information indicating means of transportation used by the user, and information indicating a position history of the user.

For example, the information processing apparatus 1 can estimate a characteristic from a geographical viewpoint of the designated store trading area as a characteristic of the designated store trading area. The characteristic of the designated store trading area from the geographical viewpoint is, for example, easiness and difficulty of store visit of the store user from the geographical viewpoint and a reason therefor and is, for example, easiness and difficulty of store visit of the store user based on a positional relationship with another store and a reason therefor. The characteristic from the geographical viewpoint of the designated store trading area may be the shape of the designated store trading area.

The characteristic from the geographical viewpoint of the designated store trading area may be a characteristic indicating a geographical relationship between the designated store and the designated store trading area. The characteristic indicating the geographical relationship between the designated store and the designated store trading area may be a characteristic indicating the shape of the designated store trading area as viewed from the designated store and may be, for example, a characteristic that the designated store trading area extends long in the northeast as viewed from the designated store.

In the second estimation processing, the information processing apparatus 1 can also estimate, as a characteristic of the designated store trading area, a characteristic indicating a relationship (for example, a distance relationship) with a facility or another store that the store user frequently visits before and after visiting the designated store.

Furthermore, in the second estimation processing, the information processing apparatus 1 can also estimate, as the characteristic of the designated store trading area, a characteristic with a related location in the designated store trading area, such as cannibalization by a related location or being a secret place in relation to a related location.

In the second estimation processing, the information processing apparatus 1 can also estimate, as the characteristic of the designated store trading area, a characteristic indicating a relationship (for example, a competitive relationship or a cooperative relationship) with another store or a facility present around the designated store or around the designated store trading area.

In the second estimation processing, the information processing apparatus 1 can also estimate a characteristic indicating a relationship between the designated store and a traffic infrastructure as the characteristic of the designated store trading area based on traffic information around the designated store or around the designated store trading area.

In the second estimation processing, the information processing apparatus 1 can also estimate a characteristic indicating a relationship between the designated store and a place of residence or a place of work of the store user as the characteristic of the designated store trading area based on information such as the place of residence or the place of work of the store user.

The information processing apparatus 1 performs the first estimation processing and the second estimation processing explained above using generative AI (Artificial Intelligence). The generative AI is, for example, text generation AI. The text generative AI is, for example, a large-scale language model learned to estimate and output the next token from an input token string and is, for example, a transformer-based model or an RNN (Recurrent Neural Network)-based model but may be a mixed model of these models or the like. The text generative AI may be a composite system combined with an identification machine or the like for preventing unauthorized use.

The transformer-based model is, for example, GPT (Generative Pre-trained Transformer) (registered trademark), PaLM2 (Pathways Language Model Version 2), or LLAMA (Large Language Model Meta AI) but is not limited to such an example. The RNN-based model is, for example, an RWKV (Receptance Weighted Key Value) but is not limited to such an example.

Note that the generative AI is desirably learned not to include personal information and the like in a generation result of the generative AI. The generative AI is disposed in an external information processing apparatus. The information processing apparatus 1 uses the generative AI via an API (Application Programming Interface). However, the generative AI may be disposed in the information processing apparatus 1.

Input information input to the generative AI is referred to as prompt. In the following explanation, the input information input to the generative AI is sometimes described as prompt. The prompt is, for example, information indicating an instruction, a request, or the like given to a language model in order to execute a specific task for language model.

For example, the information processing apparatus 1 inputs, to the generative AI, a prompt including instruction information that is information for instructing estimation of a trading area of the designated store and estimation of characteristics of the estimated trading area and information necessary for estimation of the designated store trading area and characteristics thereof and causes the generative AI to output an estimation result of the designated store trading area and the characteristics thereof. The information necessary for estimation of the designated store trading area and the characteristics thereof is, for example, the information explained above used in the first estimation processing and the second estimation processing but is not limited to such an example.

The information processing apparatus 1 uses, as information necessary for estimation of the designated store trading area using the generative AI, for example, instruction information for instructing estimation of the designated store trading area based on information of the store user. Such instruction information is, for example, information indicating an instruction to estimate, based on information concerning the store user, one or more regions where density is equal to or higher than a predetermined value as a trading area of the designated store or information indicating an instruction to estimate, based on information concerning the store user, one or more regions where density estimated using an estimation method such as kernel density estimation is equal to or higher than a predetermined value as a trading area of the designated store but is not limited to such an example.

The information processing apparatus 1 uses, as information necessary for estimation of characteristics of the designated store trading area using the generative AI, instruction information for instructing estimation of characteristics of the designated store trading area based on, for example, information concerning a user of the designated store, geographical information around the designated store, traffic information around the designated store or around the designated store trading area, information concerning a related location that is another store having a predetermined relationship with the designated store, or information concerning a related location that is another store or facility present around the designated store or around the designated store trading area.

For example, the information processing apparatus 1 can use, as the instruction information for instructing estimation of characteristics of the designated store trading area, instruction information for instructing estimation of characteristics of the designated store trading area using information indicating an instruction to estimate characteristics of the designated store trading area from a geographical viewpoint.

The information indicating the instruction to estimate characteristics of the designated store trading area from the geographical viewpoint is, for example, information indicating easiness or difficulty of store visit of the store user from the geographical viewpoint and an instruction to estimate a reason therefor or information indicating easiness or difficulty of store visit of the store user and an instruction to estimate a reason therefore based on a positional relationship with another store but is not limited to such an example.

The information processing apparatus 1 can use, as the instruction information for instructing estimation of characteristic of the designated store trading area, instruction information for instructing estimation of characteristics indicating a relationship (for example, a distance relationship) with a facility or another store that the store user frequently visits before and after visiting the designated store.

The information processing apparatus 1 can use, as the instruction information for instructing estimation of characteristics of the designated store trading area, instruction information for instructing estimation of characteristics with respect to the related location in the designated store trading area such as cannibalization by the related location or a little-known place in relation to the related location.

The information processing apparatus 1 can use, as the instruction information for instructing estimation of characteristics of the designated store trading area, instruction information for instructing estimation of characteristics indicating a relationship (for example, a competitive relationship or a cooperative relationship) with another store or facility present around the designated store or around the designated store trading area.

The information processing apparatus 1 can use, as the instruction information for instructing estimation of characteristics of the designated store trading area, instruction information for instructing, based on traffic information around the designated store or around the designated store trading area, estimation of characteristics indicating a relationship between the designated store and a transportation infrastructure.

In the second estimation processing, the information processing apparatus 1 can use, as the instruction information for instructing estimation of characteristics of the designated store trading area, instruction information for instructing, based on information such as a place of residence or a place of work of the store user, estimation of characteristics indicating a relationship between the designated store and the place of residence or the place of work of the store user.

The instruction information includes, for example, information for instructing to summarize a second estimation result, information for instructing to name a title for the summary of the second estimation result, and information for instructing to output the title and summary content. As a result, in comparison processing, the information processing apparatus 1 can output, from generative AI, information briefly indicating a comparison result between designated store trading areas with a title.

For example, the information processing apparatus 1 can input the prompt illustrated in FIG. 1 to the generative AI and cause the generative AI to output an estimation result of the designated store trading area and characteristics thereof. The instruction information of the prompt illustrated in FIG. 1 includes information of a character string “output contents summarized in 2 and 3 together with a title” as information of an output format defining how to output estimated characteristics of a trading area.

Note that, although not illustrated, the instruction information of the prompt illustrated in FIG. 1 may include information indicating an instruction for outputting the estimated trading area. For example, the instruction information of the prompt illustrated in FIG. 1 may include information of a character string “Output estimated density value of the user in the trading area in a list format for each point” but is not limited to such an example.

The information processing apparatus 1 can individually perform the first estimation processing and the second estimation processing by individually inputting a prompt of the first estimation processing and a prompt of the second estimation processing to the generative AI. In this case, the prompt of the second estimation processing includes information indicating the position of the designated store trading area estimated in the first estimation processing.

The information processing apparatus 1 can also estimate the designated store trading area using statistical processing instead of using the generative AI. For example, the information processing apparatus 1 aggregates the number of store users for each predetermined unit region based on information indicating place of sojourns of a plurality of store users and estimates a designated store trading area based on a result of the aggregation.

For example, the information processing apparatus 1 can estimate, as a trading area of the designated store, one or more regions where density is equal to or larger than a predetermined value and can estimate, as a trading area of the designated store, one or more regions where the density estimated using an estimation method such as kernel density estimation is equal to or larger than a predetermined value.

The information processing apparatus 1 can also input, for example, a prompt including processing definition information for extracting a processing type and processing target information, instruction information, and information necessary for estimation to the generative AI and acquire processing information including information indicating the processing type and the processing target information from the generative AI as output information.

The information processing apparatus 1 can perform processing corresponding to the processing type indicated by the information indicating the processing type with, for example, specific arithmetic processing or statistical processing using the processing target information. The processing type is, for example, trading area estimation or trading area characteristic estimation but is not limited to such an example. The trading area estimation is processing of estimating a designated store trading area and the trading area characteristic estimation is processing of estimating characteristics of the designated store trading area.

The generative AI extracts, as processing target information, information necessary for processing indicated by the processing type among the various kinds of information included in the prompt and outputs the information. For example, when the processing type is the trading area estimation, the generative AI extracts, as the processing target information, information necessary for estimation of the designated store trading area among the various kinds of information included in the prompt and outputs the information. The information necessary for estimation of the designated store trading area is, for example, the information explained above.

When the processing type is the trading area characteristic estimation, the generative AI extracts, as the processing target information, information necessary for estimation of characteristics of the designated store trading area among the various kinds of information included in the prompt and outputs the information. The information necessary for estimation of characteristics of the designated store trading area is, for example, the information explained above.

For example, when the generative AI is GPT of OpenAI, the information processing apparatus 1 can cause the generative AI to output processing information as output information using a function of function calling.

The generative AI may be multi-modal generative AI or the like. The multi-modal generative AI is, for example, generative AI that generates at least one of text, an image, and voice from at least one of text, an image, and voice. The multi-modal generative AI is, for example, GPT-4 Turbo with vision, gemini, CM3Leon (Chameleon Multimodal Model), or the like but is not limited to such an example.

In this case, the information processing apparatus 1 can further input, to the generative AI, as input information, instruction information further including information indicating an instruction to draw an estimated designated store trading area on a map and map information indicating a map of a region including the designated store to cause the generative AI to output map information showing the designated store trading area on the map.

Subsequently, the information processing apparatus 1 provides map information including information indicating the designated store trading area estimated in step S2 and information indicating the characteristics of the designated store trading area (step S3). For example, the information processing apparatus 1 transmits the map information including the information indicating the designated store trading area and the information indicating the characteristics of the designated store trading area to the terminal device 2 to provide, to the service user O, the map information including the information indicating the designated store trading area and the information indicating the characteristic of the designated store trading area.

For example, the information processing apparatus 1 can provide, to the service user O, the map information including the information showing the designated store trading area on the map and the information indicating the characteristics of the designated store trading area. For example, the information processing apparatus 1 provides, as map information, information in a state in which the trading area of the designated store estimated in step S2 is highlighted on a map.

As explained above, the information processing apparatus 1 receives designation of a store, performs, based on the information concerning the user of the store, the first estimation processing of estimating a trading area of the store, the designation of which has been received, and the second estimation processing of estimating characteristics of the trading area estimated in the first estimation processing, and provides map information including information indicating the estimated trading area and information indicating the characteristics of the trading area. Accordingly, the information processing apparatus 1 can provide information concerning the trading area with the trading area of the store set as an appropriate range. Accordingly, the service user O can understand a trading area of a designated store, a customer in the trading area, and the like.

In the following explanation, a configuration and the like of an information processing system including the information processing apparatus 1 and the terminal device 2 that perform the processing explained above are explained in detail.

### 2. Configuration of the Information Processing System

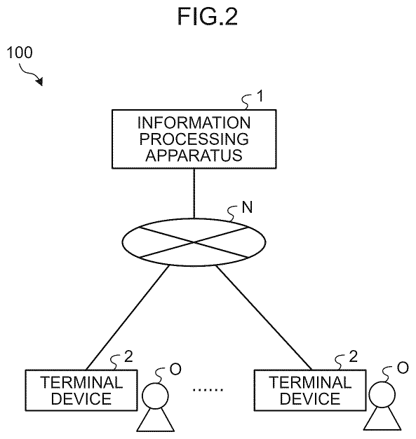

FIG. 2 is a diagram illustrating an example of a configuration of an information processing system according to the embodiment; As illustrated in FIG. 2, an information processing system 100 according to the embodiment includes the information processing apparatus 1 and a plurality of terminal devices 2.

The plurality of terminal devices 2 are used by different service users O. The terminal devices 2 are, for example, notebook PCs (Personal Computers), desktop PCs, smartphones, tablet PCs, or wearable devices. The wearable devices are, for example, smart glasses, smart watches, or the like but are not limited to such an example.

The information processing apparatus 1 and each of the terminal devices 2 are communicably connected to each other by wire or radio via a network N. Note that the information processing system 100 illustrated in FIG. 2 may include a plurality of information processing apparatuses 1 and the like.

The network N includes, for example, a WAN (Wide Area Network) such as the Internet and a mobile communication network such as LTE (Long Term Evolution), 4G (4th Generation), or 5G (5th Generation) but is not limited to such an example.

The terminal device 2 is connected to the network N via short-range wireless communication such as a mobile communication network, Bluetooth (registered trademark), or a LAN (Local Area Network) and can communicate with the information processing apparatus 1 and the like.

### 3. Configuration of the Information Processing Apparatus 1

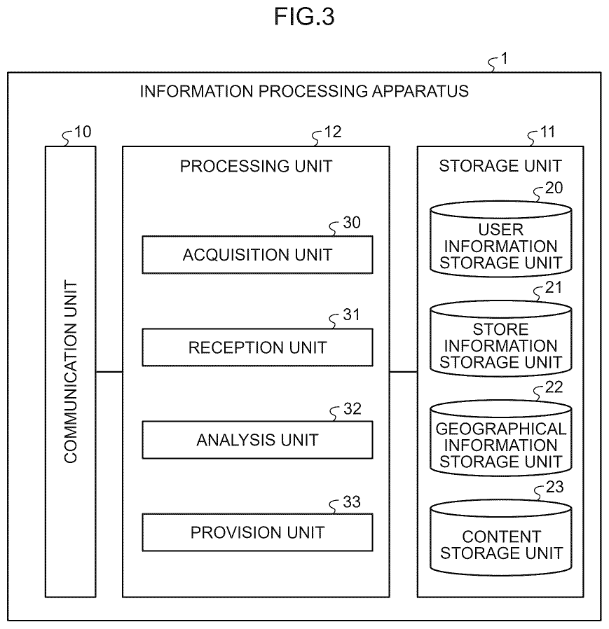

FIG. 3 is a diagram illustrating an example of a configuration of the information processing apparatus 1 according to the embodiment. As illustrated in FIG. 3, the information processing apparatus 1 includes a communication unit 10, a storage unit 11, and a processing unit 12.

### [3.1. Communication Unit 10]

The communication unit 10 is implemented by, for example, a communication module, a NIC (Network Interface Card), or the like. Then, the communication unit 10 is connected to the network N by wire or radio and transmits and receives information to and from various other devices. For example, the communication unit 10 transmits and receives information to and from the terminal device 2 via the network N.

### [3.2. Storage Unit 11]

The storage unit 11 is implemented by, for example, a semiconductor memory element such as a RAM (Random Access Memory) or a flash memory or a storage device such as a hard disk or an optical disk. The storage unit 11 includes a user information storage unit 20, a store information storage unit 21, a geographical information storage unit 22, and a content storage unit 23.

### [3.2.1. User Information Storage Unit 20]

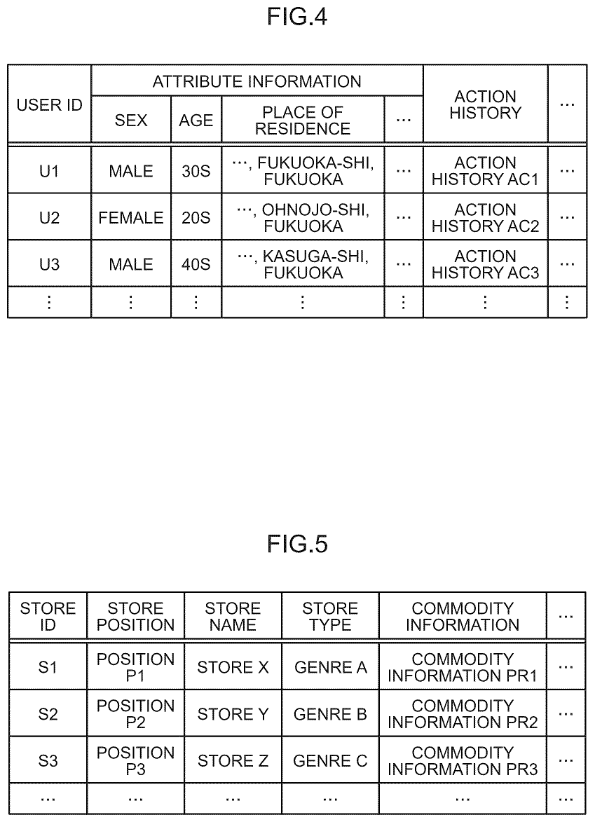

The user information storage unit 20 stores user information including information concerning a user. FIG. 4 is a diagram illustrating an example of a user information table stored in the user information storage unit 20 of the information processing apparatus 1 according to the embodiment. As illustrated in FIG. 4, the user information table stored in the user information storage unit 20 includes items such as a “user ID”, “attribute information”, and “action history”.

The “user ID” is identification information for identifying a user. The “attribute information” is attribute information of the user corresponding to the “user ID” and includes, for example, information of a psychographic attribute, information of a demographic attribute, and the like. The demographic attribute is, for example, sex, age, a place of residence, a place of work, and an occupation. The psychographic attribute is an object of interest such as travel, clothes, cars, and religion, a lifestyle, an idea, a tendency of an idea, and the like.

The “action history” is information indicating an action history of the user corresponding to the “user ID” and is, for example, information indicating a position history of the user, information indicating a use history of a store of the user, information indicating a use history of a facility of the user, information indicating a settlement history of the user in other than the store, and information indicating a use history of means of transportation of the user but is not limited to such an example.

The information indicating the use history of the store of the user is, for example, payment amounts and an average payment amount of the user in the store, contents or genres of purchased commodities or purchased services of the user in the store, and stay times and an average stay time of the user in the store but is not limited to such an example.

### [3.2.2. Store Information Storage Unit 21]

The store information storage unit 21 stores information concerning various stores. FIG. 5 is a diagram illustrating an example of a store information table stored in the store information storage unit 21 of the information processing apparatus 1 according to the embodiment. As illustrated in FIG. 5, the store information table stored in the store information storage unit 21 includes items such as a “store ID”, a “store position”, a “store name”, a “store type”, and “commodity information”.

The “store ID” is identification information for identifying a store. The “store position” is information indicating the position of the store corresponding to the “store ID” and is, for example, information indicating the latitude and the longitude of the store. The “store name” is information indicating a name of the store corresponding to the “store ID” and includes information indicating a chain store name when the store is a chain store and includes information indicating a franchise store name when the store is a franchise store.

The “Store type” is information indicating a type of the store corresponding to the “store ID” and is, for example, information indicating a genre of the store. The “commodity information” is information concerning a commodity of the store corresponding to the “store ID”.

Note that, although not illustrated, the store information storage unit 21 may include information indicating sales of the store, information indicating a floor area of the store, and information indicating the number of employees of the store.

### [3.2.3. Geographical Information Storage Unit 22]

The geographical information storage unit 22 stores geographical information. The geographical information is, for example, information indicating topography, information indicating passages, information indicating public institution routes, information indicating traffic regulations and signs, information of news articles, information concerning disasters, information of facilities and stores, and weather information but is not limited to such an example.

### [3.2.4. Content Storage Unit 23]

The content storage unit 23 stores various contents. The contents stored in the content storage unit 23 are, for example, information indicating news articles, information posted on an SNS (Social Network Service) concerning the store, information posted on a communication service concerning the store, traffic information of regions, advertisement information of the store, and weather information but are not limited to such an example.

### [3.3. Processing Unit 12]

The processing unit 12 is a controller and is implemented by, for example, a processor such as a CPU (Central Processing Unit) or an MPU (Micro Processing Unit) executing various programs (equivalent to an example of an information processing program) stored in a storage device inside the information processing apparatus 1 using a RAM or the like as a work region.

The processing unit 12 is a controller and a part or the entire processing unit 12 may be implemented by an integrated circuit such as an ASIC (Application Specific Integrated Circuit), an FPGA (Field Programmable Gate Array), or a GPGPU (General Purpose Graphic Processing Unit).

As illustrated in FIG. 3, the processing unit 12 includes an acquisition unit 30, a reception unit 31, a analysis unit 32, and a provision unit 33 and implements or executes functions and action of information processing explained below. Note that the internal configuration of the processing unit 12 is not limited to the configuration illustrated in FIG. 3 and may be another configuration if the configuration is a configuration for performing information processing explained.

### [3.3.1. Acquisition Unit 30]

The acquisition unit 30 acquires various kinds of information from an external information processing apparatus, the terminal device 2, and the like via the network N and the communication unit 10.

For example, the acquisition unit 30 acquires information concerning the use from the external information processing apparatus and causes the user information storage unit 20 to store the acquired information concerning the user. The acquisition unit 30 acquires information concerning the store from the external information processing apparatus and causes the store information storage unit 21 to store the acquired information concerning the store.

The acquisition unit 30 acquires geographical information from the external information processing apparatus and causes the geographical information storage unit 22 to store the acquired geographical information. The acquisition unit 30 acquires various contents from the external information processing apparatus and causes the content storage unit 23 to store the acquired various contents.

The acquisition unit 30 acquires various kinds of information from the storage unit 11. For example, the acquisition unit 30 acquires the information concerning the user from the user information storage unit 20 and acquires the information concerning the store from the store information storage unit 21. The acquisition unit 30 also acquires the geographical information from the geographical information storage unit 22. The acquisition unit 30 acquires the contents from the content storage unit 23.

### [3.3.2. Reception Unit 31]

The reception unit 31 receives various kinds of information. For example, the reception unit 31 receives a use request transmitted from the terminal device 2. The use request includes, for example, information indicating a position designated by the service user O or information indicating a designated region which is a region designated by the service user O.

The reception unit 31 receives designation of a store. For example, the reception unit 31 receives designation of a store by the service user O by receiving a trading area information request including information indicating the designation of the store by the service user O and transmitted from the terminal device 2.

### [3.3.3. Analysis Unit 32]

The analysis unit 32 performs first estimation processing of estimating a trading area of a designated store that is the store, the designation of which has been received by the reception unit 31, and second estimation processing of estimating characteristics of the trading area of the designated store estimated in the first estimation processing based on information concerning a store user who is a user of the designated store.

For example, in the first estimation processing, the analysis unit 32 estimates a trading area of the designated store based on the information concerning the store user. The store user is a user having a history of at least one or more of visit to the designated store, purchase of commodities at the designated store, and use of services at the designated store but is not limited to such an example and may be, for example, a user whose average stay time at the designated store is longer than or equal to a predetermined period.

Information concerning the store user includes, for example, information indicating a place of sojourn of the store user or information indicating a position history of the store user. The information indicating the place of sojourn of the store user is, for example, information indicating the latitude and the longitude of the place of sojourn of the store user but may be information indicating an address.

The place of sojourn of the store user is, for example, a location where the store user habitually stays and is, for example, a place of residence of the store user or a place of work of the store user. Note that the place of sojourn of the store user may be a place where the store user temporarily stays and may be, for example, an accommodation facility of the store user or an amusement facility visited by the store user.

Furthermore, the information concerning the store user may further include, for example, one or more pieces of information among information indicating an attribute of the store user, information indicating a use history of the designated store by the store user, information indicating a facility used by the store user, information indicating means of transportation used by the store user, and information indicating a position history of the store user.

The information indicating the attribute of the store user is a demographic attribute, a psychographic attribute, or the like of the store user. The demographic attribute is, for example, sex, age, a place of residence, a place of work, and an occupation. The psychographic attribute is an object of interest such as travel, clothes, cars, and religion, a lifestyle, an idea, a tendency of an idea, and the like.

The use history of the designated store by the store user includes, for example, payment amounts and an average payment amount of the store user, contents and genres of purchased commodities or purchased services of the store user, and stay times and an average stay time of the store user but is not limited to such an example.

For example, in the first estimation processing, the analysis unit 32 estimates a trading area of the designated store based on information indicating place of sojourns of store users. For example, the analysis unit 32 estimates a trading area of the designated store using an estimation method such as kernel density estimation based on the place of sojourns of the store users. For example, the analysis unit 32 estimates, as the trading area of the designated store, one or more regions where density is equal to or larger than a predetermined value.

In the first estimation processing, for example, the analysis unit 32 can determine whether the number of store users is equal to or larger than a predetermined number for each of predetermined unit regions. The analysis unit 32 can also estimate a set of unit regions where the number of store users is equal to or larger than the predetermined number as the trading area of the designated store.

The information indicating the place of sojourns of the store users is information indicating places of residence set by the store users or information indicating places of work set by the store users. The analysis unit 32 can estimate, based on information indicating position histories of the store users, information indicating various places of sojourns of the store users.

For example, the analysis unit 32 can estimate, based on the information indicating the position histories of the store users, places of residence of the store users, places of work of the store users, places where the store users temporarily stayed, and the like from stay patterns at positions of the store users. In the following explanation, the trading area of the designated store estimated in the first estimation processing is sometimes referred to as designated store trading area.

The analysis unit 32 can also estimate a designated store trading area based on a store user satisfying a specific condition. For example, when information indicating the specific condition is included in the trading area information request received by the reception unit 31, the information processing apparatus 1 estimates a designated store trading area from a place of sojourn of the store user satisfying the specific condition indicated by the trading area information request.

The specific condition is, for example, an attribute of the store user, a type of a place of sojourn of the store user, a facility used by the store user, means of transportation used by the store user, purchase of a specific commodity or use of a specific service of the store user in the designated store, and an average stay time of the store user in the designated store but is not limited to such an example.

In the second estimation processing, the analysis unit 32 estimates characteristics of the designated store trading area based on, for example, information concerning a user of the designated store, geographical information around the designated store, traffic information around the designated store or around the designated store trading area, information concerning a related location that is another store having a predetermined relationship with the designated store, and information concerning a related location that is another store or facility present around the designated store or around the designated store trading area.

The geographical information is, for example, information indicating topography, information indicating a passage, information indicating a public institution route, information indicating traffic regulations or signs, information of news articles, information concerning disasters, and information of facilities or stores but is not limited to such an example.

The geographical relationship between the designated store and the designated store trading area is a positional relationship between the designated store and the designated store trading area, a distance and topography between the designated store and positions of the designated store trading area, and the like but is not limited to such an example. The distances between the designated store and the positions of the designated store trading area are, for example, moving distances between the designated store and the positions of the designated store trading area but may be linear distances between the designated store and the positions of the designated store trading area. The topography between the designated store and the positions of the designated store trading area is, for example, the magnitude and the number of gradients of a moving path to the designated store, the length and the number of curves, and the like, but is not limited to such an example.

The traffic information of the designated store trading area also includes, for example, information such as information concerning a road network of the designated store trading area, information such as a state of the road network of the designated store trading area (for example, under construction or closed to traffic), and operation information of means of transportation of the designated store trading area. Other stores (examples of the associated locations) having a predetermined relationship with the designated store are, for example, the same chain stores as the designated store or the same genre as the designated store but are not limited to such an example.

The use history of the user at the related location is, for example, payment amounts and an average payment amount of the user, contents and genres of purchased commodities or purchased services of the user, and stay times and an average stay time of the store user but is not limited to such an example.

The related location information is, for example, information indicating a position (for example, the latitude and the longitude or an address) of the related location, information indicating a genre of the related location, information concerning a user who uses the related location, information indicating a use history of the user in the related location, information indicating means of transportation used by the user, and information indicating a position history of the user.

For example, the analysis unit 32 can estimate characteristics from a geographical viewpoint of the designated store trading area as the characteristics of the designated store trading area. The characteristic of the designated store trading area from the geographical viewpoint is, for example, easiness and difficulty of store visit of the store user from the geographical viewpoint and a reason therefor and is, for example, easiness and difficulty of store visit of the store user based on a positional relationship with another store and a reason therefor.

The characteristic from the geographical viewpoint of the designated store trading area may be a characteristic indicating a geographical relationship between the designated store and the designated store trading area. In this case, the analysis unit 32 estimates a characteristic indicating a geographical relationship between the designated store and the designated store trading area. The characteristic indicating the geographical relationship between the designated store and the designated store trading area may be a characteristic indicating the shape of the designated store trading area as viewed from the designated store and may be, for example, a characteristic that the designated store trading area extends long in the northeast as viewed from the designated store.

In the second estimation processing, the analysis unit 32 can also estimate, as a characteristic of the designated store trading area, a characteristic indicating a relationship (for example, a distance relationship) with a facility or another store that the store user frequently visits before and after visiting the designated store.

In the second estimation processing, the analysis unit 32 can also estimate, as the characteristic of the designated store trading area, a characteristic with respect to a related location in the designated store trading area such as cannibalization by the related location or a little-known place in relation to the related location.

Furthermore, in the second estimation processing, the analysis unit 32 can also estimate, as the characteristic of the designated store trading area, a characteristic indicating a relationship (for example, a competitive relationship, a cooperative relationship, and the like) with another store or facility around the designated store or around the designated store trading area.

In the second estimation processing, the analysis unit 32 can also estimate a characteristic indicating a relationship between the designated store and a traffic infrastructure as the characteristic of the designated store trading area based on traffic information around the designated store or around the designated store trading area.

In the second estimation processing, the analysis unit 32 can also estimate a characteristic indicating a relationship between the designated store and a place of residence or a place of work of the store user as the characteristic of the designated store trading area based on information such as the place of residence or the place of work of the store user.

The analysis unit 32 performs the first estimation processing and the second estimation processing explained above using generative AI. The generative AI is, for example, text generation AI. The text generative AI is, for example, a large-scale language model learned to estimate and output the next token from an input token string and is, for example, a transformer-based model or an RNN-based model but may be a mixed model these models. The text generative AI may be a composite system combined with an identification machine or the like for preventing unauthorized use.

The transformer-based model is, for example, GPT, PaLM2, or LLAMA but is not limited to such an example. The RNN-based model is, for example, RWKV but is not limited to such an example.

Note that the generative AI is desirably learned not to include personal information and the like in a generation result of the generative AI. The generative AI is disposed in an external information processing apparatus and the analysis unit 32 uses the generative AI via an API. However, the generative AI may be disposed in the information processing apparatus 1.

For example, the analysis unit 32 inputs, to the generative AI, a prompt including instruction information that is information for instructing estimation of a trading area of the designated store and estimation of characteristics of the estimated trading area and information necessary for estimation of the designated store trading area and the characteristics thereof and causes the generative AI to output the estimation result of the designated store trading area and the characteristics thereof. The information necessary for estimation of the designated store trading area and the characteristics thereof is, for example, the information explained above used in the first estimation processing and the second estimation processing but is not limited to such an example.

The analysis unit 32 uses, as the information necessary for the estimation of the designated store trading area using the generative AI, for example, instruction information for instructing the estimation of the designated store trading area based on the information concerning the store user. Such instruction information is, for example, information indicating an instruction to estimate, based on information concerning the store user, one or more regions where density is equal to or higher than a predetermined value as a trading area of the designated store or information indicating an instruction to estimate, based on information concerning the store user, one or more regions where density estimated using an estimation method such as kernel density estimation is equal to or higher than a predetermined value as a trading area of the designated store but is not limited to such an example.

The analysis unit 32 uses, as the information necessary for the estimation of the characteristics of the designated store trading area using the generative AI, instruction information for instructing estimation of characteristics of the designated store trading area based on, for example, information concerning the user of the designated store, geographical information around the designated store, traffic information around the designated store or around the designated store trading area, information concerning a related location that is another store having a predetermined relationship with the designated store, and information concerning a related location that is another store or facility present around the designated store or around the designated store trading area.

For example, the analysis unit 32 can use, as the instruction information for instructing the estimation of the characteristics of the designated store trading area, instruction information for instructing estimation of characteristics of the designated store trading area using information indicating an instruction to estimate characteristics of the designated store trading area from a geographical viewpoint.

The information indicating the instruction to estimate characteristics of the designated store trading area from the geographical viewpoint is, for example, information indicating easiness or difficulty of store visit of the store user from the geographical viewpoint and an instruction to estimate a reason therefor or information indicating easiness or difficulty of store visit of the store user and an instruction to estimate a reason therefore based on a positional relationship with another store but is not limited to such an example.

The analysis unit 32 can use, as the instruction information for instructing the estimation of the characteristics of the designated store trading area, instruction information for instructing estimation of characteristics indicating a relationship (for example, a distance relationship) with a facility and another store that the store user frequently visits before and after visiting the designated store.

The analysis unit 32 can use, as the instruction information for instructing the estimation of the characteristics of the designated store trading area, instruction information for instructing estimation of characteristics with respect to a related location in the designated store trading area such as cannibalization by the related location or a little-known place in relation to the related location.

The analysis unit 32 can use, as the instruction information for instructing the estimation of the characteristics of the designated store trading area, instruction information for instructing estimation of characteristics indicating a relationship (for example, a competitive relationship or a cooperative relationship) with another store or facility present around the designated store or around the designated store trading area.

The analysis unit 32 can use, as the instruction information for instructing the estimation of the characteristics of the designated store trading area, instruction information for instructing estimation of characteristics indicating a relationship between the designated store and a transportation infrastructure based on traffic information around the designated store or around the designated store trading area.

In the second estimation processing, the analysis unit 32 can use, as the instruction information for instructing the estimation of the characteristics of the designated store trading area, instruction information for instructing, based on information such as a place of residence or a place of work of the store user, estimation of characteristics indicating a relationship between the designated store and a place of residence or a place of work of the store user.

The instruction information includes, for example, information for instructing to summarize a second estimation result, information for instructing to name a title for the summary of the second estimation result, and information for instructing to output the title and summary content. Accordingly, in the comparison processing, it is possible to cause generative AI to output information briefly indicating a comparison result between designated store trading areas with a title.

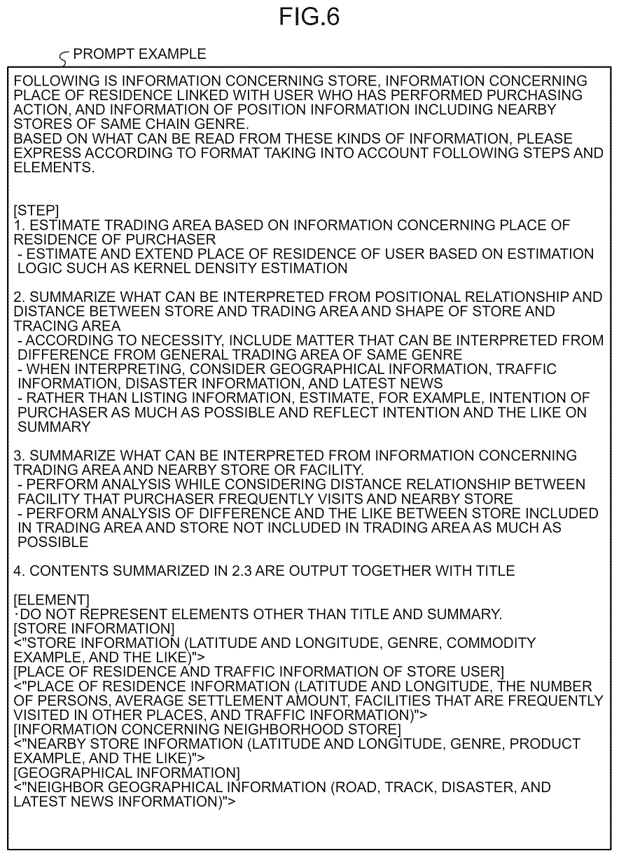

FIG. 6 is a diagram illustrating an example of a prompt used by the analysis unit 32 of the processing unit 12 in the information processing apparatus 1 according to the embodiment. For example, the analysis unit 32 inputs a prompt illustrated in FIG. 6 to the generative AI and causes the generative AI to output an estimation result of the designated store trading area and characteristics thereof. The instruction information of the prompt illustrated in FIG. 6 includes information of a character string “output contents summarized in 2 and 3 together with a title” as information of an output format that defines how to output the estimated characteristics of the designated store trading area.

Note that, although not illustrated, the instruction information of the prompt illustrated in FIG. 6 may include information indicating an instruction to output an estimated trading area. For example, the instruction information of the prompt illustrated in FIG. 6 may include information of a character string “output a density value of the user in the trading area in a list format for each point” but is not limited to such an example. Note that a part of the information other than the instruction information is omitted in the prompt illustrated in FIG. 6.

The analysis unit 32 can individually perform the first estimation processing and the second estimation processing by individually inputting a prompt of the first estimation processing and a prompt of the second estimation processing to the generative AI. In this case, the prompt of the second estimation processing includes information indicating the position of the designated store trading area estimated in the first estimation processing.

Instead of using the generative AI, the analysis unit 32 can also estimate a designated store trading area with statistical processing. For example, the analysis unit 32 aggregates the number of store users for each predetermined unit region based on information indicating place of sojourns of a plurality of store users and estimates a designated store trading area based on a result of the aggregation.

For example, the analysis unit 32 can estimate one or more regions where density is equal to or higher than a predetermined value as a trading area of the designated store and estimate one or more regions where density estimated using an estimation method such as kernel density estimation is equal to or higher than a predetermined value as a trading area of the designated store.

The analysis unit 32 can also input, for example, a prompt including processing definition information for extracting a processing type and processing target information, instruction information, and information necessary for estimation in the generative AI and acquire processing information including information indicating the processing type and the processing target information from the generative AI as output information.

The analysis unit 32 can perform processing corresponding to the processing type indicated by the information indicating the processing type using the processing target information. The processing type is, for example, trading area estimation or trading area characteristic estimation but is not limited to such an example. The trading area estimation is processing of estimating a designated store trading area and the trading area characteristic estimation is processing of estimating characteristics of the designated store trading area.

The generative AI extracts, as processing target information, information necessary for processing indicated by the processing type among the various kinds of information included in the prompt and outputs the information. For example, when the processing type is the trading area estimation, the generative AI extracts, as the processing target information, information necessary for estimation of the designated store trading area among the various kinds of information included in the prompt and outputs the information. The information necessary for estimation of the designated store trading area is, for example, the information explained above.

When the processing type is the trading area characteristic estimation, the generative AI extracts, as the processing target information, information necessary for estimation of characteristics of the designated store trading area among the various kinds of information included in the prompt and outputs the information. The information necessary for estimation of characteristics of the designated store trading area is, for example, the information explained above.

For example, when the generative AI is GPT of OpenAI, the analysis unit 32 can cause the generative AI to output processing information as output information using function of function calling.

The generative AI may be multi-modal generative AI or the like. The multi-modal generative AI is, for example, generative AI that generates at least one of text, an image, and voice from at least one of text, an image, and voice. The multi-modal generative AI is, for example, GPT-4 Turbo with vision, or gemini, CM3Leon but is not limited to such an example.

In this case, the analysis unit 32 can further input instruction information further including information indicating an instruction to draw the estimated designated store trading area on a map and map information indicating a map of a region including the designated store to the generative AI as input information to cause the generative AI to output map information indicating the designated store trading area on the map.

### [3.3.4. Provision Unit 33]

The provision unit 33 provides various kinds of information to the service user O. For example, the provision unit 33 provides various kinds of information to the service user O by transmitting the various kinds of information to the terminal device 2 via the communication unit 10 and the network N.

For example, when a use request is received by the reception unit 31, the provision unit 33 transmits store designation information including list information indicating a list of stores present in the designated region and map information of the designated region to the terminal device 2 to thereby provide the store designation information to the service user O.

When receiving the store designation information transmitted from the information processing apparatus 1, the terminal device 2 displays list information indicating a list of stores present in the designated region and map information of the designated region based on the received store designation information. In the list information, the stores present in the designated region are arranged in a list form to be individually designable. In the map information of the designated region, store figures indicating the positions of the stores present in the designated region are arranged to be individually designable on the map.

The service user O can designate a store set as an analysis target among a plurality of stores included in the list information displayed on the terminal device 2 and can designate a store figure corresponding to the store set as the analysis target among a plurality of store figures included in the map information displayed on the terminal device 2. When the service user O designates a store or a store figure, the terminal device 2 transmits, to the information processing apparatus 1, a trading area information request in which information indicating the store designated by the service user O or information indicating a store corresponding to the store figure designated by the service user O is included as store information.

When the reception unit 31 receives the trading area information request, the provision unit 33 provides map information including information indicating a designated store trading area that is a trading area of the designated store estimated by the analysis unit 32 and information indicating characteristics of the designated store trading area.

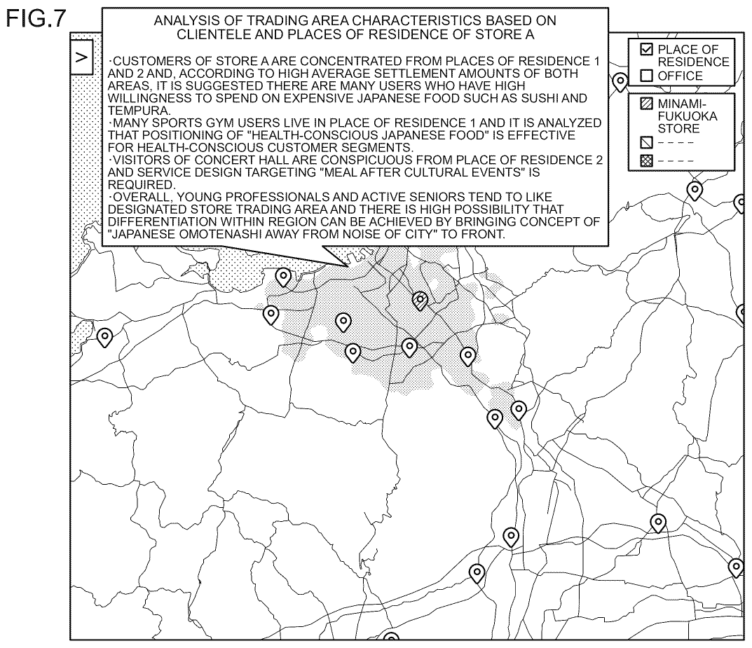

FIG. 7 is a diagram illustrating an example of map information provided by the provision unit 33 of the processing unit 12 in the information processing apparatus 1 according to the embodiment and displayed on the terminal device 2. In the example illustrated in FIG. 7, as the information indicating the characteristics of the designated store trading area, the map information includes information of a character string “analysis of trading area characteristics based on clientele and places of residence of a store A \n\n. customers of the store A are concentrated from places of residence 1 and 2 and, according to high average settlement amounts in both the areas, it is suggested that there are many users who have high willingness to spend on expensive Japanese food such as sushi and tempura. \n. Many sports gym users live in the place of residence 1 and it is analyzed that positioning of “health-conscious Japanese food” is effective for health-conscious customer segments. \n. Visitors of a concert hall are conspicuous from the place of residence 2 and service design targeting “meal after cultural events” is required. \n. Overall, young professionals and active seniors tend to like the designated store trading area and there is a high possibility that differentiation within a region can be achieved by bringing the concept of “Japanese omotenashi away from noise of a city” to the front”.

For example, the provision unit 33 can provide, to the service user O, map information including information indicating the designated store trading area on the map and information indicating characteristics of the designated store trading area. For example, the provision unit 33 provides, as the map information, information concerning a state in which the trading area of the designated store estimated by the analysis unit 32 is highlighted on the map.

### 4. Processing Procedure

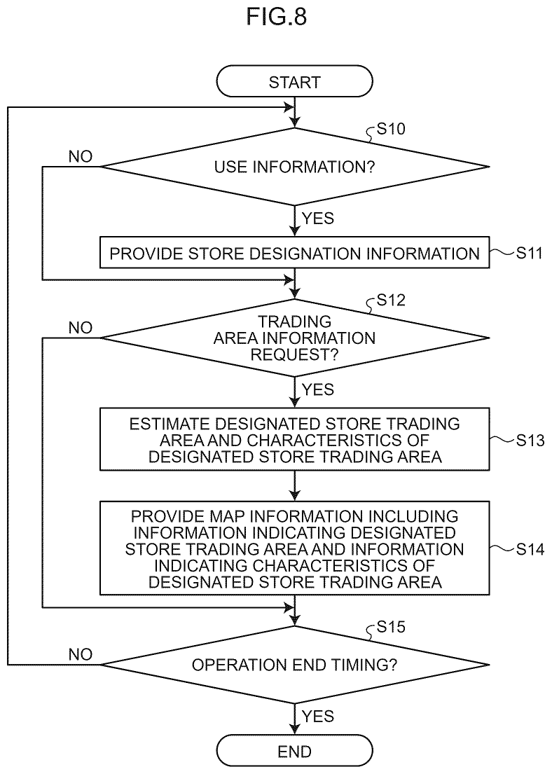

Subsequently, a procedure of information processing by the processing unit 12 of the information processing apparatus 1 according to the embodiment is explained. FIG. 8 is a flowchart illustrating an example of information processing by the processing unit 12 of the information processing apparatus 1 according to the embodiment.

As illustrated in FIG. 8, the processing unit 12 of the information processing apparatus 1 determines whether a use request from the service user O has been received (step S10). When determining that the use request from the service user O has been received (step S10: Yes), the processing unit 12 provides store designation information to the service user O (step S11).

When the processing in step S11 ends or when determining that a use request from the service user O has not been received (step S10: No), the processing unit 12 determines whether a trading area information request from the service user O has been received (step S12).

When the processing unit 12 determines that a trading area information request from the service user O has been received (Step S12: Yes), the processing unit estimates a designated store trading area and characteristics of the designated store trading area (Step S13). Then, the processing unit 12 provides, to the service user O, map information including information indicating the designated store trading area and information indicating the characteristics of the designated store trading area (step S14).

When the processing in step S14 ends or when determining that a trading area information request from the service user O has not been received (step S12: No), the processing unit 12 determines whether operation end timing has come (step S15). For example, when the information processing apparatus 1 is turned off, the processing unit 12 determines that the operation end timing has come.

When determining that the operation end timing has not come (step S15: No), the processing unit 12 shifts the processing to step S10. When determining that the operation end timing has come (step S15: Yes), the processing unit 12 ends the processing illustrated in FIG. 8.

### 5. Modifications

For example, in the second estimation processing, the analysis unit 32 can also estimate, as a characteristic of the trading area of the designated store estimated in the first estimation processing, moving speed of the store user at positions in the trading area of the designated store based on information indicating a position history of the store user.

In the first estimation processing, the analysis unit 32 can also estimate a trading area of the designated store for each predetermined period based on, for example, information concerning the store user for each predetermined period. In this case, the provision unit 33 can also provide the map information shown on the map while automatically switching, in time series, the trading area of the designated store for each predetermined period estimated in the first estimation processing.

In the second estimation processing, the analysis unit 32 can also estimate characteristics of the designated store trading area for each predetermined period based on information of the store user for each predetermined period. In this case, the provision unit 33 can also provide map information shown on the map while automatically switching, in time series, the characteristics of the designated store trading area for each predetermined period estimated in the second estimation processing.

In the second estimation processing, the analysis unit 32 can estimate characteristics of the designated store trading area using, as information concerning the designated store, posted information to an SNS concerning the designated store or posted information to a communication service concerning the designated store. For example, the analysis unit 32 can estimate, as the characteristics of the designated store trading area, for example, a level of a frequency of posting concerning the designated store to the SNS of the store user in the designated store trading area and a level of a frequency of posting concerning the designated store to the communication service of the store user in the designated store trading area.

In this case, the analysis unit 32 inputs, to generative AI, a prompt including, as instruction information, information for instructing estimation of, for example, a level of a frequency of posting concerning the designated store to the SNS of the store user in the designated store trading area and a level of a frequency of posting concerning the designated store to the communication service of the store user in the designated store trading area.

### 6. Hardware Configuration

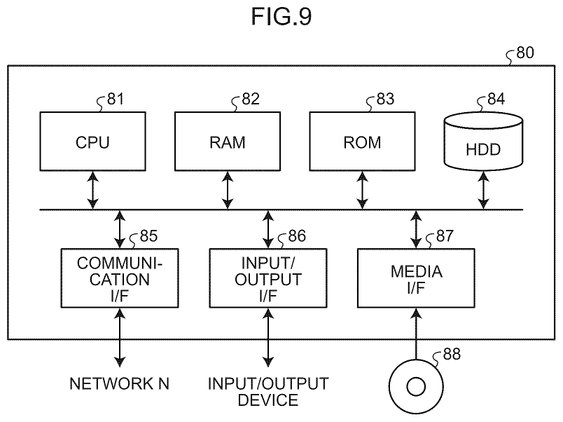

The information processing apparatus 1 according to the embodiment explained above is implemented by, for example, the computer 80 having a configuration as illustrated in FIG. 9. FIG. 9 is a hardware configuration diagram illustrating an example of the computer 80 that implements the functions of the information processing apparatus 1 according to the embodiment. The computer 80 includes a CPU 81, a RAM 82, a ROM (Read Only Memory) 83, an HDD (Hard Disk Drive) 84, a communication interface (I/F) 85, an input/output interface (I/F) 86, and a media interface (I/F) 87.

The CPU 81 operates based on a program stored in the ROM 83 or the HDD 84 and controls the units. The ROM 83 stores a boot program to be executed by the CPU 81 when the computer 80 is started, a program relying on hardware of the computer 80, and the like.

The HDD 84 stores a program to be executed by the CPU 81, data to be used by the program, and the like. The communication interface 85 receives data from other devices via the network N (see FIG. 2), sends the data to the CPU 81, and transmits data generated by the CPU 81 to the other devices via the network N.

The CPU 81 controls output devices such as a display and a printer and an input device such as a keyboard or a mouse via the input/output interface 86. The CPU 81 acquires data from the input device via the input/output interface 86. The CPU 81 outputs the generated data to the output device via the input/output interface 86.

The media interface 87 reads a program or data stored in the recording medium 88 and provides the program or the data to the CPU 81 via the RAM 82. The CPU 81 loads the program from the recording medium 88 onto the RAM 82 via the media interface 87 and executes the loaded program. The recording medium 88 is, for example, an optical recording medium such as a DVD (Digital Versatile Disc) or a PD (Phase change rewritable Disk), a magneto-optical recording medium such as an MO (Magneto-Optical disk), a tape medium, a magnetic recording medium, or a semiconductor memory.

For example, when the computer 80 functions as the information processing apparatus 1 according to the embodiment, the CPU 81 of the computer 80 implements the function of the processing unit 12 by executing the program loaded on the RAM 82. The HDD 84 stores data in the storage unit 11. The CPU 81 of the computer 80 reads these programs from the recording medium 88 and executes the programs. However, as another example, the CPU 81 may acquire these programs from another device via the network N.

### 7. Others

Among the kinds of processing explained in the embodiment explained above, all or a part of the processing explained as being automatically performed can be manually performed or all or a part of the processing explained as being manually performed can be automatically performed by a publicly-known method. Besides, the processing procedures, the specific names, and the information including various data and parameters explained and illustrated in the document explained above and the drawings can be optionally changed except when being specifically described. For example, the various kinds of information illustrated in the figures are not limited to the illustrated information.

The components of the devices illustrated in the figures are functionally conceptual and are not always required to be physically configured as illustrated. That is, a specific form of distribution and integration of the devices is not limited to the illustrated form and all or a part of the devices can be functionally or physically distributed and integrated in any unit according to various loads, usage situations, and the like.

The configuration of the information processing apparatus 1 explained above can be flexibly changed, for example, the information processing apparatus 1 may be implemented by a terminal device and a server computer, may be implemented by a plurality of server computers, or may be implemented by calling an external platform or the like with an API, network computing, or the like depending on functions.

The embodiment and the modifications explained above can be combined as appropriate within a range that does not contradict the processing contents.

### 8. Effects

As explained above, the information processing apparatus 1 according to the embodiment includes the reception unit 31, the analysis unit 32, and the provision unit 33. The reception unit 31 receives designation of a store. The analysis unit 32 performs, based on information concerning a user of the store, first estimation processing of estimating a trading area of a store for which designation has been received by the reception unit 31 and second estimation processing of estimating characteristics of the trading area estimated in the first estimation processing. The provision unit 33 provides map information including information indicating the trading area estimated by the analysis unit 32 and information indicating the characteristics of the trading area. Accordingly, the information processing apparatus 1 can provide information concerning the trading area with the trading area of the store set as an appropriate range.

In addition, in the first estimation processing, the analysis unit 32 estimates a trading area based on the information indicating the place of sojourn of the user of the store whose designation has been received by the reception unit 31. Accordingly, the information processing apparatus 1 can provide information concerning the trading area with the trading area of the store set as an appropriate range.

In the second estimation processing, the analysis unit 32 estimates characteristics of the trading area based on a geographical relationship between the store, the designation of which has been received by the reception unit, and the trading area. Accordingly, the information processing apparatus 1 can provide information concerning the trading area with the trading area of the store set as an appropriate range.

In the second estimation processing, the analysis unit 32 estimates characteristics of the trading area based on the information concerning the user of the store, the designation has been received by the reception unit. Accordingly, the information processing apparatus 1 can provide information concerning the trading area with the trading area of the store set as an appropriate range.

In the second estimation processing, the analysis unit 32 estimates characteristics of the trading area based on information concerning another store or facility around the store, the designation of which has been received by the reception unit, the other store or facility having a predetermined relationship with the store, the designation of which has been received by the reception unit 31. Accordingly, the information processing apparatus 1 can provide information concerning the trading area with the trading area of the store set as an appropriate range.

The analysis unit 32 performs the second estimation processing using generative AI. Accordingly, the information processing apparatus 1 can provide information concerning the trading area with the trading area of the store set as an appropriate range.

The analysis unit 32 performs the first estimation processing using the generative AI. Accordingly, the information processing apparatus 1 can provide information concerning the trading area with the trading area of the store set as an appropriate range.

The provision unit 33 provides, as map information, information concerning a state in which the trading area estimated by the analysis unit 32 is highlighted on a map. Accordingly, the information processing apparatus 1 can provide information concerning the trading area with the trading area of the store set as an appropriate range.

Although the embodiment of the present application is explained above in detail with reference to the drawings, this is merely exemplification, and the present invention can be implemented in other forms to which various modifications and improvements are applied based on the knowledge of those skilled in the art, including the aspects described in the disclosure of the invention.

The “section, module, and unit” explained above can be replaced with “means”, “circuit”, and the like. For example, the acquisition unit can be replaced with acquiring means or an acquisition circuit.

What is claimed is:

1. An information processing apparatus comprising:
a reception unit that receives designation of a store;
an analysis unit that performs, based on information concerning a user of the store, first estimation processing of estimating a trading area of the store, the designation of which has been received by the reception unit, and second estimation processing of estimating characteristics of the trading area estimated in the first estimation processing; and
a provision unit that provides map information including information indicating the trading area estimated by the analysis unit and information indicating the characteristics of the trading area.

2. The information processing apparatus according to claim 1, wherein
the analysis unit in the first estimation processing, estimates the trading area based on information indicating a place of sojourn of the user of the store, the designation of which has been received by the reception unit.

3. The information processing apparatus according to claim 1, wherein
the analysis unit, in the second estimation processing, estimates the characteristics of the trading area based on a geographical relationship between the store, the designation of which has been received by the reception unit, and the trading area.

4. The information processing apparatus according to claim 1, wherein
the analysis unit, in the second estimation processing, estimates the characteristics of the trading area based on information concerning another store or facility around the store, the designation of which has been received by the reception unit, the other store or facility having a predetermined relationship with the store, the designation of which has been received by the reception unit.

5. The information processing apparatus according to claim 1, wherein
the analysis unit performs the second estimation processing using generative AI.

6. The information processing apparatus according to claim 5, wherein
the analysis unit performs the first estimation processing using the generative AI.

7. The information processing apparatus according to claim 1, wherein
the provision unit provides, as the map information, information concerning a state in which the trading area estimated by the analysis unit is highlighted on a map.

8. An information processing method executed by a computer, the information processing method comprising:
a receiving step of receiving designation of a store;
an analyzing step of performing, based on information concerning a user of the store, first estimation processing of estimating a trading area of the store, the designation of which has been received in the receiving step, and second estimation processing of estimating characteristics of the trading area estimated in the first estimation processing; and
a providing step of providing map information including information indicating the trading area estimated by the analyzing step and information indicating the characteristics of the trading area.

9. A non-transitory computer-readable storage medium storing an information processing program for causing a computer to execute:
a receiving procedure of receiving designation of a store;
an analyzing procedure of performing, based on information concerning a user of the store, first estimation processing of estimating a trading area of the store, the designation of which has been received in the receiving procedure, and second estimation processing of estimating characteristics of the trading area estimated in the first estimation processing; and
a provision procedure of providing map information including information indicating the trading area estimated by the analyzing procedure and information indicating the characteristics of the trading area.
